(19) United States
(12) Patent Application Publication
(10) Pub. No.: US 2024/0303913 A1
(43) Pub. Date: Sep. 12, 2024

(54) PHYSICALLY-BASED EMITTER ESTIMATION FOR INDOOR SCENES

(71) Applicant: QUALCOMM Incorporated, San Diego, CA (US)

(72) Inventors: Yinhao ZHU, La Jolla, CA (US); Rui ZHU, La Jolla, CA (US); Hong CAI, San Diego, CA (US); Fatih Murat PORIKLI, San Diego, CA (US)

(21) Appl. No.: 18/180,797

(22) Filed: Mar. 8, 2023

(51) Int. Cl. G06T 15/50; G06T 7/593

(52) U.S. Cl. CPC G06T 15/506; G06T 7/593

(57) ABSTRACT

Systems and techniques are provided for physical-based light estimation for inverse rendering of indoor scenes. For example, a computing device can obtain an estimated scene geometry based on a multi-view observation of a scene. The computing device can further obtain a light emission mask based on the multi-view observation of the scene. The computing device can also obtain an emitted radiance field based on the multi-view observation of the scene. The computing device can then determine, based on the light emission mask and the emitted radiance field, a geometry of at least one light source of the estimated scene geometry.

### FIELD

Aspects of the present disclosure generally relate to rendering indoor scenes given a single or multiple view input. For example, aspects of the present disclosure include systems and techniques for performing physically-based emitter estimation for indoor scenes.

### INTRODUCTION

Inverse rendering for indoor scenes has been a challenging task in computer vision. The goal in these efforts is to estimate intrinsic properties of an indoor scene from single-view or multi-view observations, including geometry, materials and spatially-varying lighting. In single-view inverse rendering, given limited information of scene appearance and inherent ambiguity between geometry, materials and lighting, most of the methods either heavily rely on heuristic priors and regularization, or learned priors from large collection of indoor scenes. Multi-view inverse rendering assumes multi-view observation of the scene usually coupled with given camera poses, which greatly alleviates appearance ambiguity, hence solvable with optimization-based method using view-synthesis objectives.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems and techniques for enabling a physically-based light estimation approach for inverse rendering of indoor scenes. According to one illustrative example, an apparatus for performing light source estimation is provided. The apparatus includes at least one memory and at least one processor coupled to at least one memory and configured to: obtain an estimated scene geometry based on a multi-view observation of a scene; obtain a light emission mask based on the multi-view observation of the scene; obtain an emitted radiance field based on the multi-view observation of the scene; and determine, based on the light emission mask and the emitted radiance field, a geometry of at least one light source of the estimated scene geometry.

In another illustrative example, a method for performing light source estimation is provided. The method includes: obtaining an estimated scene geometry based on a multi-view observation of a scene; obtaining a light emission mask based on the multi-view observation of the scene; obtaining an emitted radiance field based on the multi-view observation of the scene; and determining, based on the light emission mask and the emitted radiance field, a geometry of at least one light source of the estimated scene geometry.

In another illustrative example, a non-transitory computer-readable medium is provided that has stored thereon instructions that, when executed by one or more processors, cause the one or more processors to: obtain an estimated scene geometry based on a multi-view observation of a scene; obtain a light emission mask based on the multi-view observation of the scene; obtain an emitted radiance field based on the multi-view observation of the scene; and determine, based on the light emission mask and the emitted radiance field, a geometry of at least one light source of the estimated scene geometry.

In another illustrative example, an apparatus for performing part segmentation is provided. The apparatus includes: means for obtaining an estimated scene geometry based on a multi-view observation of a scene; means for obtaining a light emission mask based on the multi-view observation of the scene; means for obtaining an emitted radiance field based on the multi-view observation of the scene; and means for determining, based on the light emission mask and the emitted radiance field, a geometry of at least one light source of the estimated scene geometry.

In some aspects, one or more of the apparatuses described herein is, is part of, and/or includes an extended reality (XR) device or system (e.g., a virtual reality (VR) device, an augmented reality (AR) device, or a mixed reality (MR) device), a mobile device (e.g., a mobile telephone or other mobile device), a wearable device, a wireless communication device, a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyroscopes, one or more accelerometers, any combination thereof, and/or other sensor.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example sing-view inverse rending of an indoor scene, in accordance with some examples;

FIG. 2 illustrates a multi-view inverse rendering of an indoor scene using optimization-based methods, in accordance with some examples;

FIG. 3 illustrates an example of the output of an application of an emitter estimation approach, in accordance with some examples;

FIG. 4 illustrates a block diagram of an approach of obtaining a scene geometry, material and emission estimation, in accordance with some examples;

FIG. 5 illustrates images showing emitter representation and initialization, in accordance with some examples;

FIG. 6 illustrates an estimated scene geometry and a lamp geometry masked by an emission mask, in accordance with some examples;

FIG. 7 illustrates an estimated environment map via scattering observations through windows in all views onto a global environment map, in accordance with some examples;

FIG. 8 illustrates an estimated outdoor environment map in which the sun is captured and a ground truth environment is used, in accordance with some examples;

FIG. 9A illustrates an initial environment map estimation, a fitted environment map and a ground truth map, in accordance with some examples;

FIG. 9B illustrates a bidirectional reflectance distribution function with albedo values, roughness values and metallic values, in accordance with some examples;

FIG. 10 illustrates a rendering equation, in accordance with some examples;

FIG. 11 illustrates a scene with various approximated values for a rendering equation using a multilayer perceptron, in accordance with some examples;

FIG. 12 illustrates a scene with various approximated values for a rendering equation using a mesh function, in accordance with some examples;

FIG. 13 is a flow diagram illustrating an example method of performing light estimation, in accordance with some examples; and

FIG. 14 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

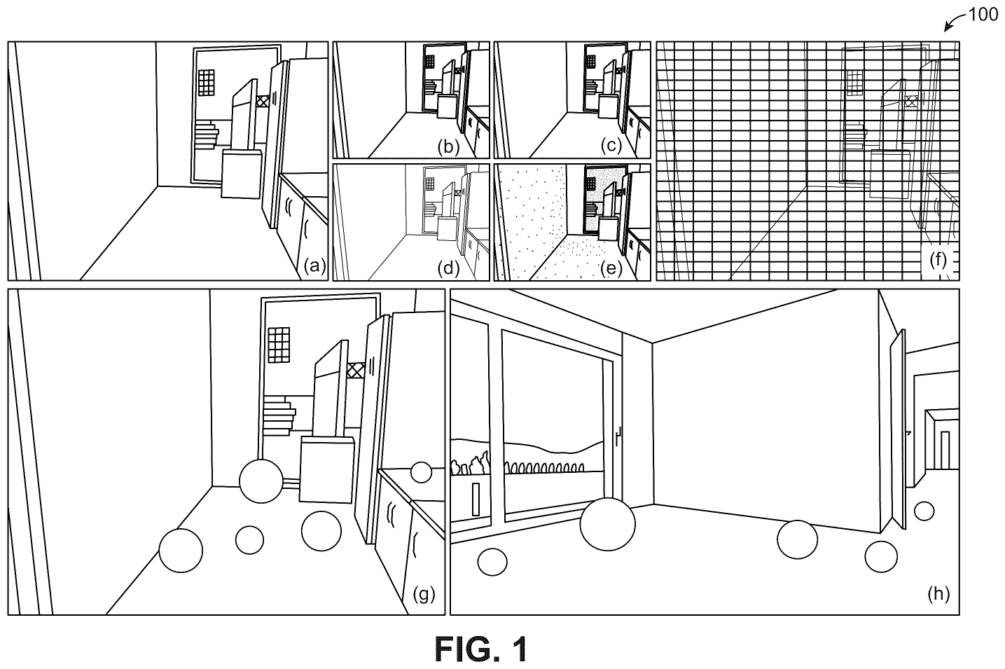

As noted above, inverse rendering for indoor scenes is a challenging task in computer vision. A goal of inverse rendering is to estimate intrinsic properties of an indoor scene from a single view (e.g., a single image) or multi-view (e.g., multiple images) observations, including geometry, materials and spatially-varying lighting. FIG. 1 illustrates an example of a series of images 100, including an image (a) through an image (h). Given a single image of an indoor scene (e.g., image (a)), the system can recover its diffuse albedo (e.g., as shown in image (b)). Albedo is the fraction of light that a surface reflects. For example, if all light is reflected from a respective surface or at a respective point on a surface, then the albedo is equal to one. In another example, if 30% of the light is reflected, then the albedo is 0.3 for that particular surface or location on the surface.

A system or apparatus can recover data associated with a scene such as the normal values (e.g., as shown in image (c) of FIG. 1), the specular roughness values (e.g., as shown in image (d), a depth value (e.g., as shown in image (e)), and spatially varying lighting (e.g., as shown in image (f)). Methods can also enable downstream applications like object insertion even for specular objects (e.g., as shown in image (g) of FIG. 1) and in real images (e.g., as shown in image (h)). Obtaining an accurate and usable representation of the scene can enable further uses such as inserting images or enabling physical robots to move about a room and perform tasks accurately.

Systems and techniques are described herein performing multi-view inverse rendering for indoor scenes. In general, multi-view inverse rendering for indoor scenes is an emerging task in recent years and has seen mostly optimization-based methods which estimate dense properties of all surfaces, including emitted radiance and emission masks. However, existing methods do not model emitters as parametric models (e.g., single semantic objects with emission properties including global radiance), making it difficult to control each emitter independently and heuristically (e.g., to turn on/off one lamp or to change one lamp from white light to red light). Moreover, those method rely on expensive path tracing to optimize dense emission properties which could take hours to days to converge in terms of training a neural network, and may yield uneven emission over emitter surface.

Furthermore, recent years has seen methods using neural radiance fields for single-object inverse rendering tasks or intrinsic decomposition of indoor scenes. These methods are either focused on a single-object setting where lighting and emitters are assumed to be global, or do not attempt to recover emission data at all. One existing approach attempts to model lighting as spatially-varying neural radiance field, but no parametric emitters are modeled, and no physically-based light transportation constraints are incorporated to ensure the physical plausibility of the estimated lighting.

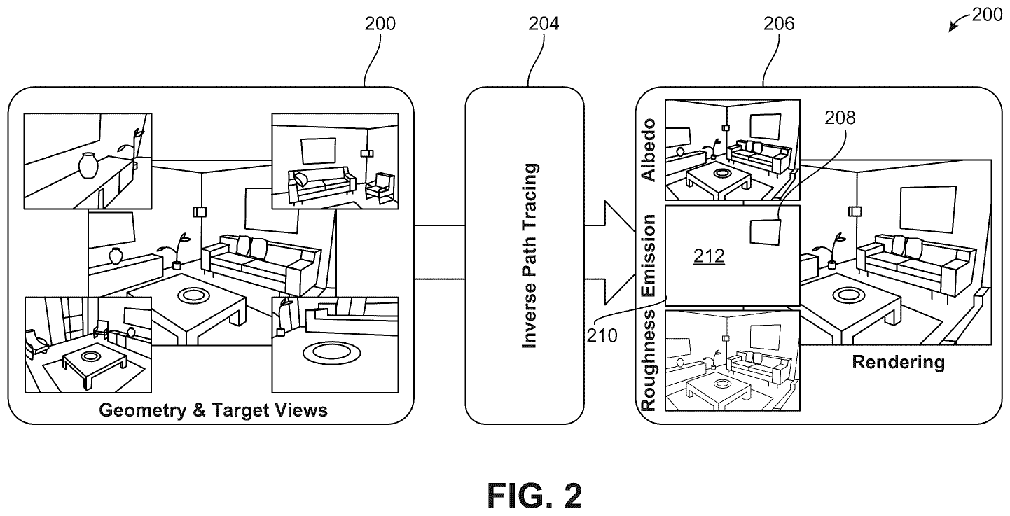

FIG. 2 is a diagram 200 illustrating a scene lighting and emitter estimation approach in which a multi-view inverse rendering is performed using optimization-based methods. Dense surface properties including materials (e.g., albedo and roughness) and emission (e.g., emission values and masks) can be estimated from geometry and target views 202 of a scene where inverse path tracing 204 is applied to generate the rendering 206 with values associated with the material and emission properties.

The emission mask can include a value of “1” for an object that emits light, such as the region 208 in FIG. 2 which is a flat-screen TV. The emission mask 210 identifies the emitting portions of the image (e.g., region 208) and the non-emitting portions of the image (e.g., region 212). The emission mask will identify such emitting and non-emitting regions for each light source in the scene.

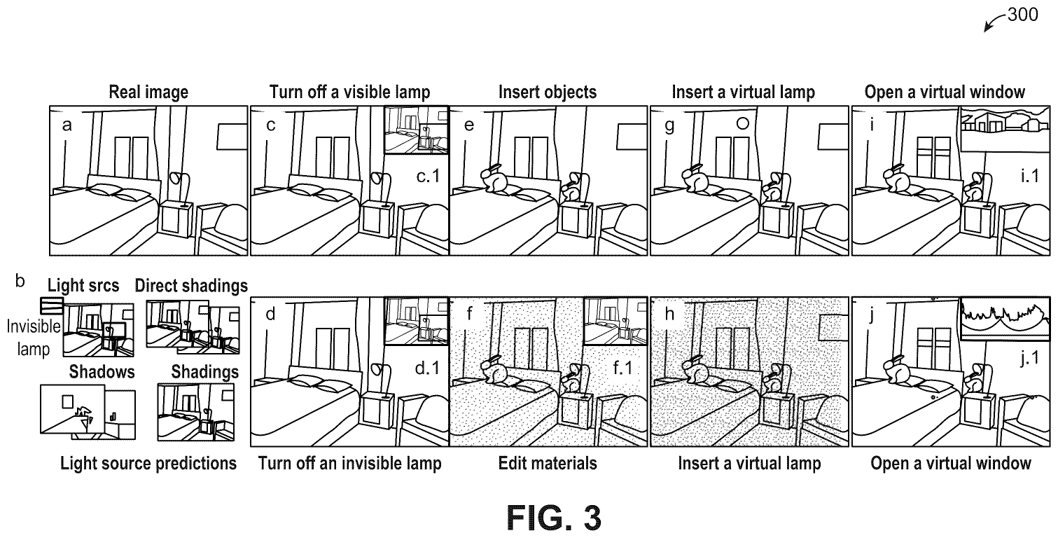

Lighting estimation for indoor scenes is valuable for downstream tasks including light editing and virtual object insertion. Early algorithms model indoor lighting as a global environment map which consider the environment map as a single emitter surrounding the internals of the scene. Later works evolve with spatially-varying dense lighting but no global consistency or semantic emitters are modeled, thus not suitable for heuristic lighting editing. Some approaches model lighting as dense emitted radiance and emission masks on scene surfaces, again failing to identify emitters. In another aspect, some approaches adopt parametric representation of emitters as semantic objects in the scene, with other approaches modeling emitters as distant point lights, and more recently model both area lights (e.g., a lamp which is an area light of geometry and single global radiance) and outdoor environment maps. This approach is shown in FIG. 3 with an example of the output and applications 300 of such an approach on emitter estimation, where two types of parametric emitters are considered. For example, the approach allows for lamps to be turned off, objects to be inserted, virtual light sources to be inserted, and a virtual window to be opened. One example of such an approach is found in Li, Zhengqin, et al., “Physically-Based Editing of Indoor Scene Lighting from a Single Image”, Computer Vision—ECCV 20-22; 17^{th} European Conference, Tel Aviv, Israel, Oct. 23-27, 2022, Proceedings, Part VI, incorporated herein by reference.

Due to limited generalization ability of the above approach, the method simplifies outdoor environment map with three spherical Gaussian lobes, sacrificing high-frequency outdoor details and leading to artifacts in rendering windows and strong highlights or shadows cast through the window. Lamps are modeled with fixed geometry by back-projecting depth maps to three-dimensional space, resulting in fixed geometry often with artifacts, and unable to optimize in later stages. For example, the approach generates a geometry of the first light source (which can be of different types such as an indoor light source like a lamp or an outdoor light source like the sun or other light outside building) to be differentially optimized after initialization.

The systems and techniques described herein provide a pipeline for end-to-end light source estimation and light editing, which can be based on Neural Radiance Fields (NeRF) to model full 3D scene geometry and lighting and can take a sequence of scene observations as input. The systems and techniques can explicitly estimate parametric physical light sources and globally-consistent light transportation in an end-to-end trainable pipeline that can be optimized over one scene. A differentiable neural renderer as shown below is able to efficiently render the scene.

The systems and techniques described herein are applicable to various applications, including Augmented Reality (AR), indoor navigation, etc., where understanding the lighting in an indoor environment is crucial for light editing, material editing, virtual object insertion, and home robot manipulation in challenging light conditions. The systems and techniques are suitable for a broad range of applications and products, including scene editing and light editing for AR (mobile, glasses), home robot navigation, etc.

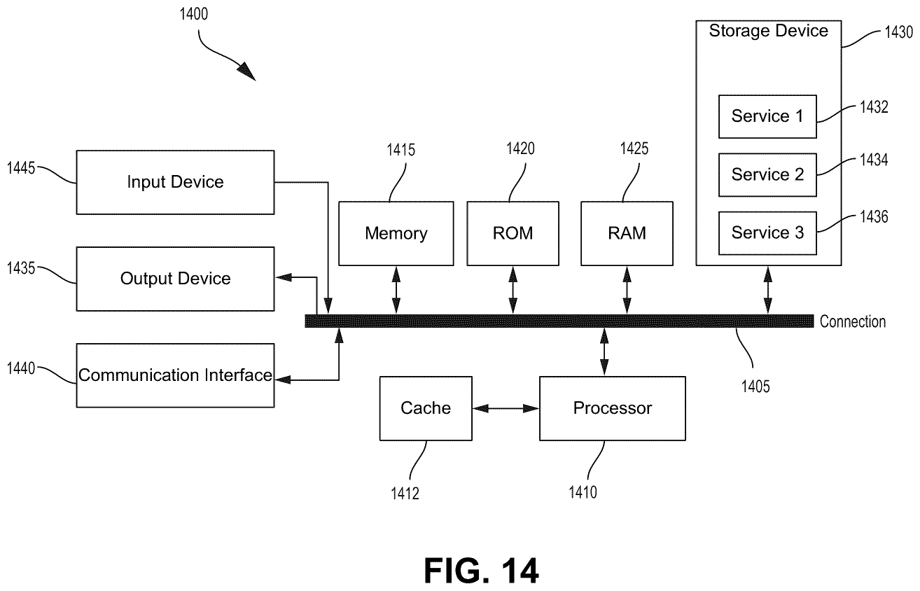

The systems and techniques described herein can use light estimation to better distinguish emission and reflection in a scene and provides an initialization process for an emitter from a stored emitted radiance field. The systems and techniques provide emitter optimization as well using differentiable rendering. An example apparatus (e.g., the system 1400 of FIG. 14) for performing light source estimation to address the issues outlined above can include at least one memory; and at least one processor coupled to at least one memory and configured to: obtain an estimated scene geometry based on a multi-view observation of a scene; obtain a light emission mask based on the multi-view observation of the scene; obtain an emitted radiance field based on the multi-view observation of the scene; and determine, based on the light emission mask and the emitted radiance field, a geometry of at least one light source of the estimated scene geometry. The geometry can be optimized and configured such that scene editing and individual light editing is possible over previous processes.

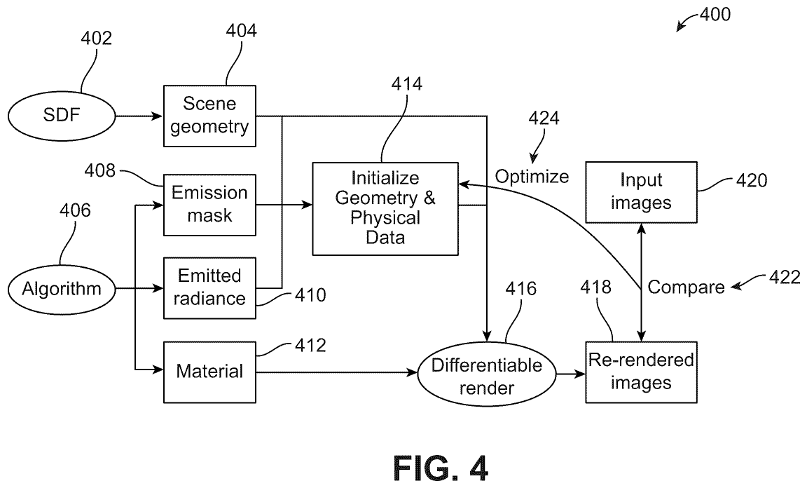

FIG. 4 illustrates a block diagram 400 of an approach of obtaining a scene geometry, material and emission estimation, in accordance with some examples. The obtained data can be utilized to initialize an initialization engine 414 in novel ways that enable new capabilities such as being able to control each emitter in the scene independently and heuristically in the sense of seeking a quicker solution or capability of independently controlling emitters. In this approach, a multi-view observation of an indoor scene is given. An algorithm (e.g., such as a MonoSDF (mono signed distance function)) 402 can be used to acquire a scene geometry 404. In one example of using the MonoSDF approach, the scene geometry 404 can be represented as a signed distance function (SDF). A signed distance function is a continuous function ƒ that, for a given three-dimensional (3D) point, returns the point's distance to the closest surface:

$$f : {ℝ}^{3} \to ℝ x ↦ s = S D F ( x ) . \qquad ( 1 )$$

In Equation (1), x is the 3D point and s denotes the corresponding SDF value. A system can parameterize the SDF function with learnable parameters θ and investigate several different design choices for representing the function: explicit as a dense grid of learnable SDF values, implicit as a single multilayer perceptron (MLP), or hybrid using an MLP in combination with single- or multi-resolution feature grids. Details about this example approach for obtaining or generating the scene geometry 404 can be found in Yu, Zehao, et al. “Monosdf: Exploring monocular geometric cues for neural implicit surface reconstruction”, arXiv preprint arXiv:2206.00665 (2022), incorporated herein by reference. Other algorithms or approaches are contemplated as well of obtaining or generating the scene geometry 404. For example, any three-dimensional reconstruction method could be used such as multiview stereo or neural radiance field. In general, the algorithm 402 yields a scene geometry 404 represented with an SDF. With the given geometry, the system (e.g., system 1400 of FIG. 4) can estimate the material data 412, the emitted radiance field 410 and the emission mask 408. The data for the emission mask 408, the emitted radiance field 410 and the material data 412 can be determined or obtained off-line as part of a pre-processing pipeline.

Other data can be used to initiate an emitter via the initialization engine 414. For example, an algorithm 406 can be used to obtain one or more of an emission mask 408, an emitted radiance field 410, and/or data regarding the material data 412. The data can be estimates based on the operation of the algorithm 406. In one aspect, the emission mask 408 can be represented as: α=NNₑₘᵢₜ(x) where α∈[0, 1] is the likelihood to have emission on the surface point. If a equals 1, the respective point in the scene is emitting. If α equals 0, then the point is not emitting, althought it might reflect.

The initialization of the emitter via the initialization engine 414 can utilize the scene geometry 404, the emission mask 408 and the emitted radiance field 410. The geometry and physical characteristics of the scene can be used to initialize the emitter (or multiple emitters in a scene) via the initialization engine 414. An apparatus (e.g., the system 1400 of FIG. 14) can include an initialization engine or module represented as a block representing the initialization engine 414 in FIG. 4 to initialize where each emitter (or light source) is, the geometry of each emitter in a scene and the physical intensity of the emitter. The apparatus can also optimize the emitter using differentiable rendering.

In one aspect, it can be assumed that the scene geometry 404 is given either from three-dimensional reconstruction for real scenes or from ground-truth geometry of synthetic scenes. The scene geometry can be represented as a set of triangles or a triangle mesh.

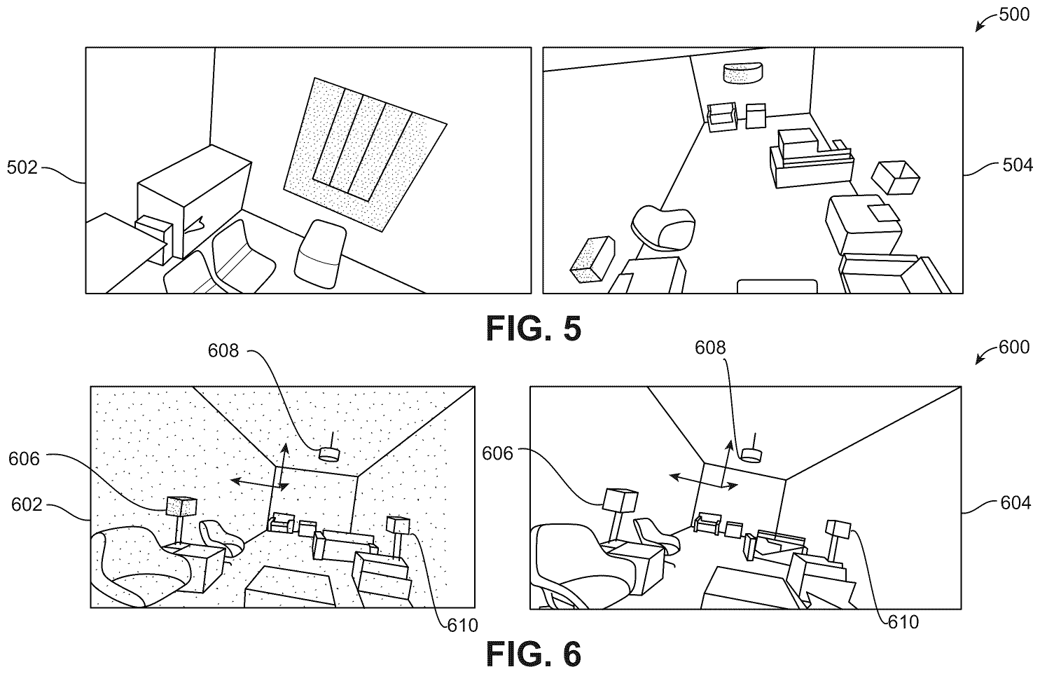

FIG. 5 illustrates images 500 illustrating the emitter representation and initialization, in accordance with some examples. A first image 502 shows initializing a geometry of windows. The second image 504 illustrates an initializing of lamps or other indoor light sources. These initializations are performed based on a given estimated scene geometry 404 and/or the emission masks 408.

Given the emission mask 408, area lights (e.g., lamps or other sources of light such as ceiling or wall lights) and windows through which light from an outdoor environment map cast into the room, are masked on the estimated scene geometry 404. With the scene geometry 404 and including the availability of the vertices of respective triangles on a triangle mesh, on each surface point there is an emission mask 408 that can be defined. Where the emission mask 408 has a value of “1” for a given surface location, then the associated vertices can be selected to identify emitters. The emission mask 408 can be defined on the triangle mesh, including the material data 412. This process generates or yields lamps (or other indoor lights) as individual shapes, and windows as holes carved out in the wall as shown in image 502.

Each lamp can be represented as a semantic object with implicit geometry (e.g., a signed distance function or signed distance field (SDF)) and physical properties (e.g., a global radiance). SDF is one way to represent the geometry. An input to the process can include a location and an output can be the SDF value. If a point or location in a scene is outside of a surface, the value is positive, if the point is inside the surface then the value is negative. A position on the surface has a value of zero. The input is any spatial location and the output is the SDF to the surface. This can be used as the representation of the geometry.

The representation allows for a hybrid geometry representation where implicit SDF parameters can be converted to triangle meshes with marching cubes, allowing for lamp geometry to be differentiably optimized after initialization. The marching cube step may or may not be differentiable. For example, a neural implicit evolution method may be applied to optimize the scene SDF, which is a procedure that does not require the marching cube step to be differentiable. An example of “marching cubes” is an algorithm that creates triangle models of constant density surfaces from 3D data. Using a divide-and-conquer approach to generate inter-slice connectivity, a case table can be created that defines a triangle topology. The algorithm processes the 3D data in scan-line order and calculates triangle vertices using linear interpolation. The gradient of the original data can be normalized and used as a basis for shading the models. The detail in images produced from the generated surface models is the result of maintaining the inter-slice connectivity, surface data, and gradient information present in the original 3D data. The “marching cubes” approach is just one of a number of different approaches that can be applied to convert scene geometry parameters to a set of triangles or a triangle mesh. The process enables each emitter (e.g. lamp or other indoor light source) to be separately and independently optimized after initialization. Representing the emitters with implicit geometry in SDF makes it easier to optimize the data as described herein.

In another aspect, indoor light sources (e.g., the lamps 606, 610 shown in the image 602 of FIG. 6) can be modeled with physically properties as global radiance values, suggesting that the light sources emit light omnidirectionally and evenly from all surfaces of the light source. FIG. 6 illustrates images 600 including a first image 602 of an estimated scene geometry and a lamp geometry masked by an emission mask. The geometry of the light sources is carved out from the estimated scene geometry 404 with the emission mask 408. The initial radiance value can be acquired via sampling the emitted radiance field 410 on lamp surface locations and taking the median value of the emitted radiance field 410. When there is a set of triangles or a triangle mesh available for the geometry, for each triangle of a triangle mesh the system can sample the radiance from the respective triangle. Sampling the radiance can occur with two types of data including the location within the respective triangle and the direction (e.g., the direction normal to the surface or point on the respective triangle). The system can pass this data the radiance field to query the radiance. For example, as described in more detail below, the system may sample a number of points xᵢ on each triangle and can determine, for the respective triangle, whether the mean value of the sampled data is greater than a threshold value. If the mean value for a triangle is greater than the threshold value, then the system can classify the triangle as an emitter. The system can classify the respective triangle as a non-emitter if the mean value of the sampled data is at or below the threshold value for the respective triangle.

In the image 602 of FIG. 6, there are three light sources, including lamp 606, ceiling light 608, and lamp 610. Initialized emitter radiances can be visualized as lines (not shown) on each respective lamp surface, with the length of the lines corresponding to magnitude. The radiance can be determined as a scalar value and can be omnidirectional and uniform in one aspect. Image 604 represents a ground truth scene and lamp geometry with ground truth lamp radiance lines (not shown).

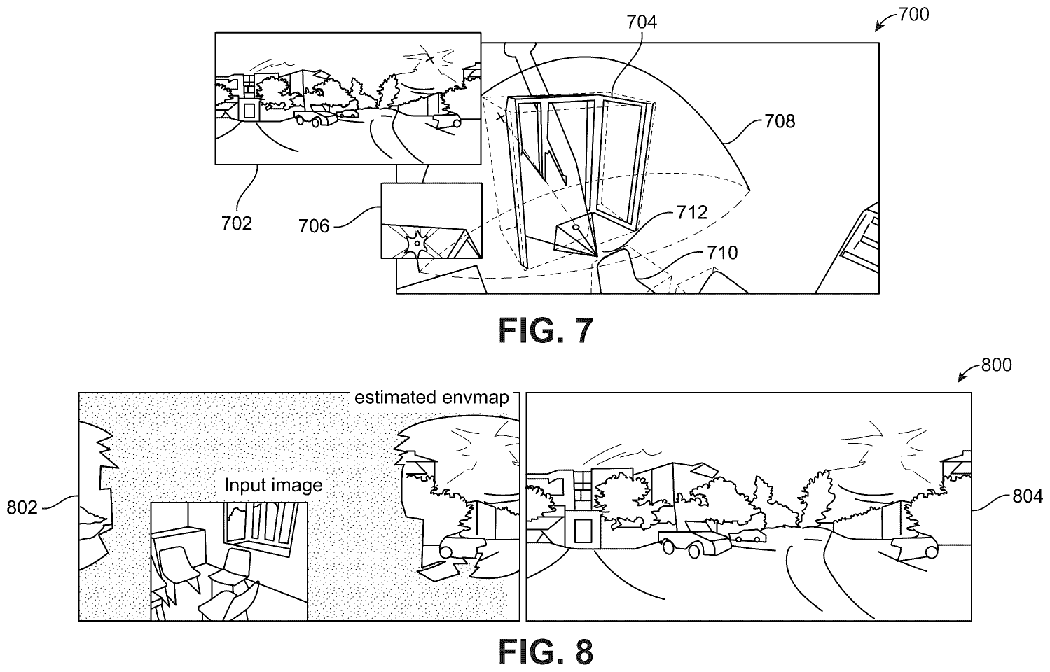

FIG. 7 illustrates an image 700 of an estimated environment map 702 via scattering observations through windows 704 in all views onto a global environment map 708. From windows 704, a given window can be carved out or represented as a hollow structure in the wall, as shown in the image 706. Observation through windows, such as in image 706, can include one frame with the sun (or other outdoor light source) directly observed. Lighting can represent a global environment map 708 which can be envisioned as an upper hemisphere and can be dependent on an angle and may not be dependent on a spatial location (e.g., the spatial location may not be a factor, as the dependency is based on where the observer is looking or gazing). By definition, the global environment map does not depend on location, since it represents far distance lighting. It can be assumed that the sun or outdoor light source is very far from a viewer in the scene or room. The system can sample the rays, and if the rays pass through the hollow structure, then the system can obtain an observation of the environment map.

FIG. 8 illustrates images 800 including a first image of an estimated outdoor environment map associated with image 802 in which the sun is captured and a second image of a ground truth environment shown in image 804. In one example, the sun or other outdoor light source or light emitter can be used and least one window or representation of a window can have a direct view of the outdoor light source. The image 802 shows an inset of one input image and an estimated environmental map. The image 804 illustrates a ground truth environment.

From the image 802, the system can sample the camera rays and obtain the environmental map. The image 802 shows a gathering of all the available views together. However, shown in the image 802 are some missing parts as it shows the input image and the estimated environment map but other areas are blank. The system can parameterize the upper hemisphere represented as a global environmental map 708 shown in FIG. 7. Using two observations of the window, the system can select the views that the pass through the window and to fill in the missing details of image 802. The MLP can be used to fill in the gaps. Camera rays can be sampled on the observations and corresponding image intensity can be scattered onto the global environment map 708 from a representative point 712 in FIG. 7 to formulate the initial estimation.

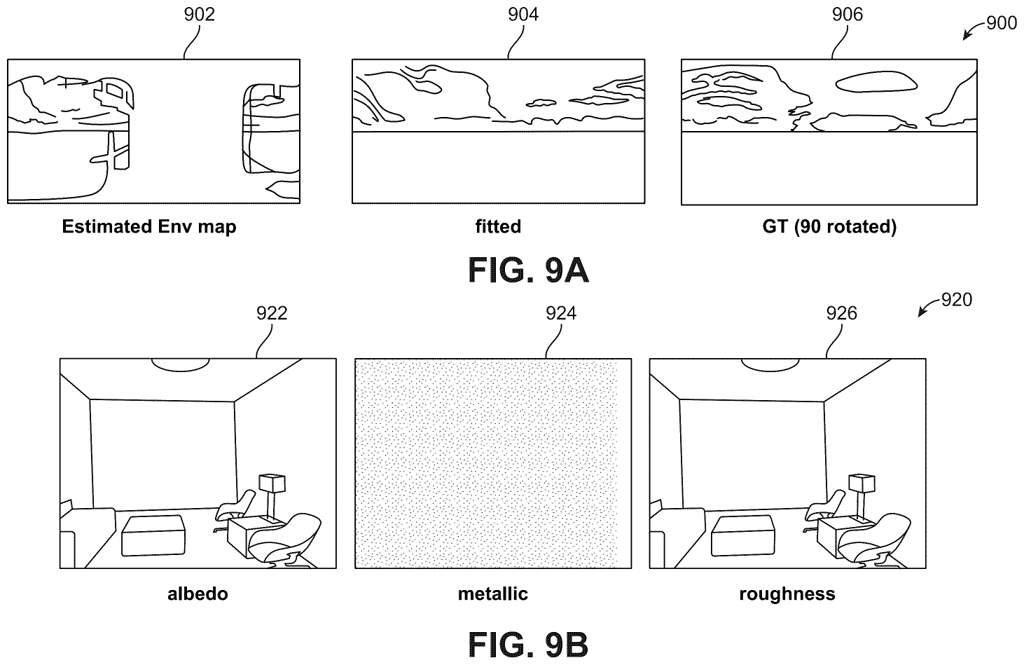

FIG. 9A illustrates images 900 including an initial environment map estimation shown in image 902, a fitted environment map shown in image 904 and a ground truth map shown in the image 906. In order to allow window radiance (e.g., the environment map estimation of image 902) to be differentiably optimizable in later stages, similar to lamps, the disclosed approach is to convert the initial partial environment map into an implicit representation with multi-layer perceptron (MLP). Note that in the estimated environment map shown in image 902, there are missing parts to the image. There is a need to fill in the gaps from the initial estimation. To this end, the system fits an MLP to the initial environment map as shown in image 904 and optimizes with consistency in valid regions. The final representation for outdoor environment map is an MLP which covers the entire hemisphere visible from the window as shown in image 904. Image 906 represents a ground truth of the image.

FIG. 9B illustrates images 920 of a bidirectional reflectance distribution function with albedo values, roughness values and metallic values. For example, a bidirectional reflectance distribution function (BRDF) can illustrate albedo data as shown in image 922, metallic data as shown in image 924, and roughness data as shown in image 926. This material data can correspond to the material data 412 shown in FIG. 4. Note that the albedo data in image 922 will typically be presented as different colors which represent the fraction of light reflected at each point on the surface. The metallic data shown in image 924 is all gray indicating that there are no metallic surfaces in the image. The roughness data in image 926 can be black and white, gray or can be colored to present visually a roughness value or characteristic at each surface point in the scene. This data provides information about the material properties in the scene.

In one aspect, the material data 412 can be represented as BRDF (a, m, σ)=NN_{brdf}(x) where a∈[0, 1]³ albedo (base color); σ∈[0, 1] roughness; m∈[0, 1] metallic; and x∈R³ position of a surface point.

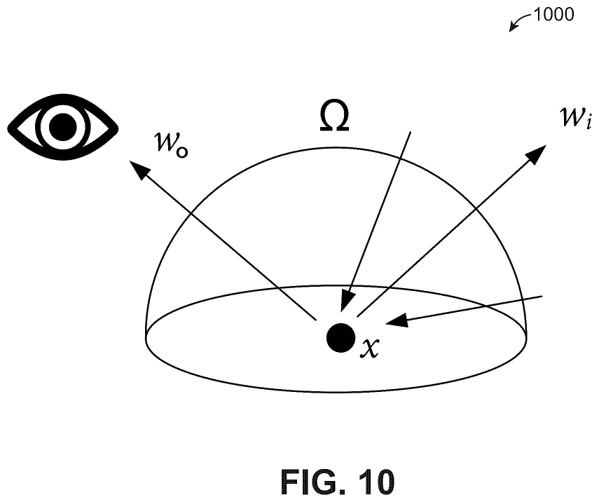

FIG. 10 is a diagram 1000 illustrating a differentiable rendering technique (e.g., utilizing a differentiable rendering equation) that can be used to describe the total amount of light emitted from a point x along a viewing direction, in accordance with some examples. The technique illustrated in FIG. 10 illustrates a given function for incoming light and a BRDF.

A rendering equation in one example of an integral equation in which the equilibrium radiance leaving a point is given as the sum of emitted plus reflected radiance under a geometric optics approximation. The various realistic rendering techniques in computer graphics attempt to solve this equation. The physical basis for the rendering equation is the law of conservation of energy. In one aspect, assume that L denotes radiance, at each particular position and direction, the outgoing light (denoted Lₒ) can be the sum of the emitted light (denoted Lₑ) and the reflected light. The reflected light itself is the sum from all directions of the incoming light (denoted Lᵢ) multiplied by the surface reflection and cosine of the incident angle.

The rendering equation may be written in the form:

$${L}_{0} ( x , {w}_{0} , λ , t ) = {L}_{e} ( x , {w}_{0} , λ , t ) + {\int }_{Ω} {f}_{r} ( x , {w}_{i} , {w}_{o} , λ , t ) {L}_{i} ( x , {w}_{i} , λ , t ) ( {w}_{i} \cdot n ) d {w}_{i} , \qquad ( 2 )$$

where L₀ (x, ωₒ, λ, t) is the total spectral radiance of wavelength λ directed outward along direction at time t, from a particular position x, x is the location in space, ωₒ is the direction of the outgoing light, λ is a particular wavelength of light, t is time, Lₑ (x, ωₒ, λ, t) is emitted spectral radiance, ∫_{Ω} . . . wᵢ is an integral over Ω, Ω is the unit hemisphere centered around n containing all possible values for ωi, where ωᵢ*, fᵣ(x, ωᵢ, λ, t) is the bidirectional reflectance distribution function, the proportion of light reflected from ωᵢ to ωₒ at position x, time t, and at wavelength λ, ωᵢ is the negative direction of the incoming light, Lᵢ (x, ωᵢ, λ, t) is spectral radiance of wavelength λ coming inward toward x from direction ωᵢ at time t, n is the surface normal at x, and ωᵢ*n is the weakening factor of outward irradiance due to incident angle, as the light flux is smeared across a surface whose area is larger than the projected area perpendicular to the ray.

Several features of equation (2) include its linearity (it is composed only of multiplications and additions), and its spatial homogeneity (it is the same in all positions and orientations). These features of equation (2) provide a wide range of factorings and rearrangements of the equation are possible. Equation (2) is a Fredholm integral equation of the second kind, similar to those that arise in quantum field theory.

In equation (2), the spectral and time dependence (Lₒ) may be sampled at or integrated over sections s of the visible spectrum to obtain, for example, a trichromatic color sample. A pixel value for a single frame in an animation may be obtained by fixing t; motion blur can be produced by averaging Lₒ over some given time interval (e.g., by integrating over the time interval and dividing by the length of the interval).

In one example, a solution to the rendering equation can be the function Lₒ. The function Lᵢ is related to Lₒ via a ray-tracing operation. For example, the incoming radiance from some direction at one point is the outgoing radiance at some other point in the opposite direction.

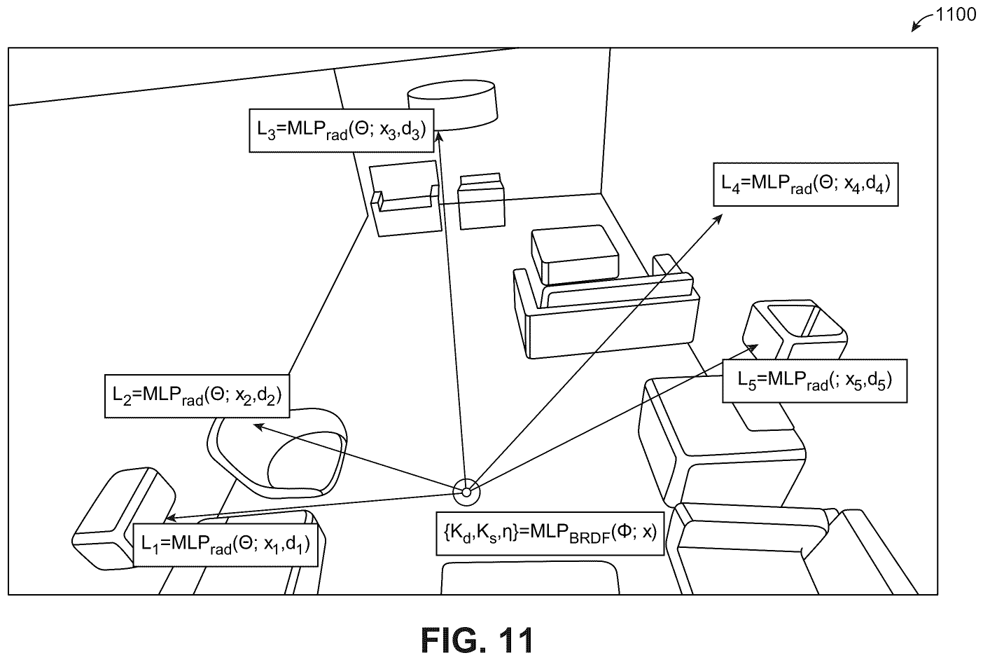

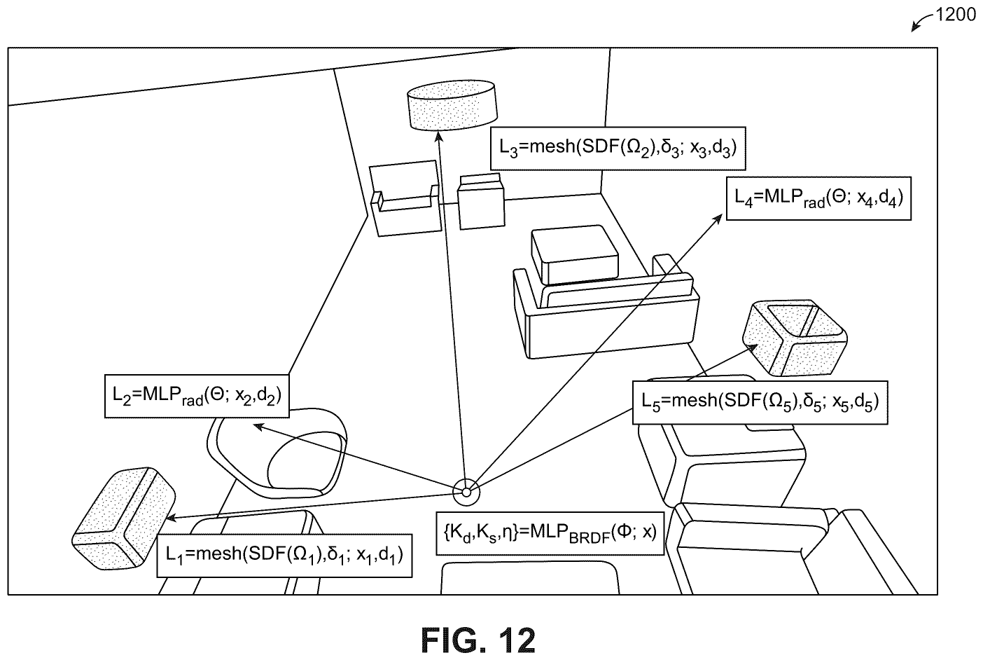

FIG. 11 illustrates a scene 1100 with various approximated values for a rendering equation mentioned above using a multilayer perceptron. FIG. 12 illustrates a scene 1200 with various approximated values for a rendering equation similar to that used above and using a mesh function.

According to the techniques described herein, the system may query N incident radiance samples at locations all over the scene, regardless of the shape type of the sampled locations (e.g., both emitter or non-emitting objects). With an explicitly parameterized emitter j model, Lᵢ=mesh(SDF(Ωⱼ), δⱼ; xᵢ, dᵢ), which is both an explict mesh parameterized by optimizable SDF parameters Ωⱼ, and physical properties (e.g., universal single radiance intensity δⱼ for lamps), the system can then query the emitter j model instead of the radiance cache MLP for the incident radiance of sample i. The benefits of this approach can include by differentiating queries on emitter from queries on non-emission surfaces, the rendered image will be a function of emitter parameters, which allows the user to differentiably optimize emitter parameters by minimizing errors on the rendered image. Furthermore, queries on emitter surfaces with the original radiance cache MLP may return varying intensities for a single emitter of area lights (e.g., lamps), while the results ideally should be uniform instead, equal to the single radiance intensity δⱼ.

However, using the techniques described herein, the system is able to better regularize the radiance space by explicitly estimating parameters for each emitter, and guarantecing the radiance samples on one emitter are constrained by a smaller set of parameters (e.g., emitter shape Ωⱼ and physical properties δⱼ). Windows as emitters are parameterized differently from lamps, by Lᵢ=MLP(δⱼ; dᵢ), because windows have known shapes as cut-outs in the wall thus no optimizable geometry parameters, and they provide non-spatially-varying lighting because outdoor light cast into the room from windows is assumed to originate from distant global environment maps (e.g., sun and clouds), and the incident radiance only depend on radiance directions dᵢ but not locations inside the room xᵢ.

Once the rendering equation is formulated as functions of BRDF parameters and additional emitter parameters, the system is able to optimize both parameters with image rendering loss, and to arrive at accurate physically parameterized emitters (e.g., a lamp of boxy shape, with intensity of 100 per-RGB channel) which can be useful for downstream applications including intuitive light editing and relighting.

The differentiable rendering equation associated with FIG. 10 with parameterized emitters only uses emitters for direct lighting component (e.g., incident radiance that do not originate from emitters are queried with the radiance cache MLP). However, there are other differentiable rendering techniques which allow using only emitters for both direct and indirect lighting. One of such technique is inverse path tracing (IPT), where all sampled rays originating from location x branch into ray paths which all end up on the emitters. In this way, the pre-trained radiance cache MLP used by some approaches is no longer useful, and the present system will be able to optimize emitter parameters with no pretrained components. However, IPT is known to be drastically less efficient as it requires extensive path sampling, and less stable and unbiased. The IPT is a possible second stage which can be used for emitter optimization, with a good initialization from the aforementioned pipeline. In this way, IPT is expected to converge faster, and is able to improve global consistency of radiance across the entire scene.

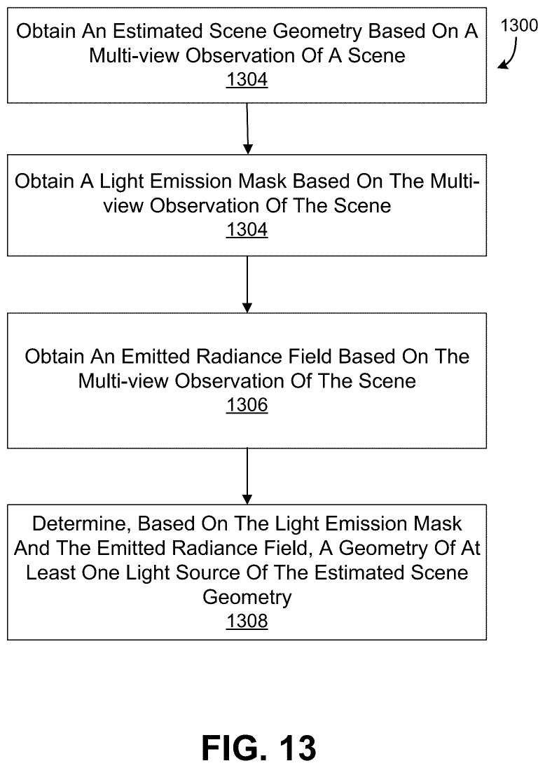

FIG. 13 is a flow diagram illustrating an example of a process 1300 for performing an initialization of an emitter from a scene or for performing light estimation. The operations of the process 1300 may be implemented as software components that are executed and run on one or more processors (e.g., processor 1410 of FIG. 14 and/or other processor(s)).

At block 1302, the process 1300 can include obtaining an estimated scene geometry based on a multi-view observation of a scene (e.g., the scene geometry of 404 of FIG. 4 obtained or generated from, for example, the MonoSDF algorithm 402 or other algorithm). The scene may be an indoor scene. However, other scenes can be contemplated as well, such as a partial indoor scene or other scenes which have similar characteristics to indoor scenes. The estimated scene geometry can be represented as a signed distance function.

In one aspect, the signed distance function can include a continuous function f. For instance, for a given three-dimensional point, the function f returns a value representing a distance of the given three-dimensional point to a closest surface in the scene. The estimated scene geometry can be generated based on one or more of depth fusion (e.g., truncated signed distance function or TSDF fusion), monocular depth estimation (e.g., using single image), multiview stereo, and/or neural radiance field.

At block 1304, the process 1300 can include obtaining a light emission mask based on the multi-view observation of the scene (e.g., the emission mask 408 of FIG. 4). The light emission mask can include information indicating a likelihood of a respective surface point in the scene being associated with emission of light. In one illustrative aspect, the light emission mask can include a first value for surface points associated with emission of light and a second value for surface points not associated with emission of light, the second value being different from the first value.

At block 1306, the process 1300 can include obtaining an emitted radiance field based on the multi-view observation of the scene (e.g., the emitted radiance field 410 of FIG. 4).

At block 1308, the process 1300 can include determine, based on the light emission mask and the emitted radiance field, a geometry of at least one light source of the estimated scene geometry (e.g., initializing the one or more emitters via an initialization engine 414 in FIG. 4).

In one aspect, the process 1300 can further include generating an individual shape for the at least one light source or generating a hole defined in a wall in the scene representing the at least one light source (e.g., the image 502 of FIG. 5 shows a geometry of a window as a hole or opening in a wall).

In one aspect, a first light source of the at least one light source can include an indoor light (e.g., the lamp 606, 610 or ceiling light 608 in images 602, 604 of FIG. 6) and a second light source of the at least one light source comprises a window (e.g., the window shown in image 502 of FIG. 5). The first light source can be represented as having physical properties modeled as global radiance values (e.g., a single scalar value). The process 1300 can include determining the global radiance values based on sampling the emitted radiance field on surface locations of the first light source to generate sampled data and determining a mean or median value of the sampled data. Not shown in image 604 are arrow or vectors projected from the surfaces of the emitters (e.g., the lamps 606, 610 and the ceiling light 608), which having a length of each line that corresponds to a magnitude of the radiance.

In one aspect, the process 1300 can include representing the first light source as a semantic object with implicit geometry associated with a signed distance function (SDF) to generate implicit SDF parameters. For the purpose of extracting emitter geometry from the scene geometry, in one aspect the process 1300 can directly assume the geometry is a triangle mesh. The geometry reconstruction results could be an SDF, or a mesh, but in one aspect it does not matter as long as the approach includes converting the results to a mesh. The process 1300 can further include converting the implicit SDF parameters to a set of triangles or a triangle mesh. In some cases, an assumption can be made that an emission is the same for all the points on each triangle and that an emitter reflects zero light.

In some aspects, the process 1300 can sample a set of points of a respective triangle of the set of triangles to generate sampled data. For example, the system may sample 100 points xᵢ on each triangle, get αᵢ=NNₑₘᵢₜ(xᵢ), i=1, . . . , 100. The process 1300 can then determine, for the respective triangle, whether the mean value of the sampled data is greater than a threshold value. For example, if a mean([x₁, . . . , x₁₀₀])>0.45, then a respective triangle is classified as an emitter. In this regard, the process 1300 can obtain an emitter geometry. The threshold value of 0.45 is an example for illustrative purposes, and other threshold values can be used. The process 1300 can classify the respective triangle as an emitter based on the mean value of the sampled data being greater than the threshold value for the respective triangle. The process 1300 can classify the respective triangle as a non-emitter based on the mean value of the sampled data is at or below the threshold value for the respective triangle. Classifying a triangle as a non-emitter can indicate that the triangle is not a light source.

In some cases, for each training image view, if the respective triangle intersects with a camera ray, the process 1300 can obtain a corresponding red-green-blue (RGB) value to generate a set of pixel values (e.g., RGB values) and then set an emission value η to the median of the pixel values as part of a step of getting an emission value for the triangle or a portion of the triangle. When RGB values are used, the approach is based on the RGB color model in which the red, green, and blue are primary colors and are added together in various ways to reproduce a broad array of different colors.

In another aspect, the process 1300 can determine the respective triangle intersects with a camera ray. Based on the respective triangle intersecting with the camera ray, the process 1300 can obtain a pixel value corresponding to the respective triangle to generate a set of pixel values. The process 1300 can then set an emission value for a median value of the set of pixel values.

In one aspect, a multi-view observation of the scene can include at least one input image in which a dominant light source is viewable through the window (e.g., as shown in the window in image 706 of FIG. 7). The process 1300 can further include estimating an initial partial environment map based on sampled camera rays and corresponding image intensity scattered onto a global environmental map. The process 1300 can convert the initial partial environment map to an implicit representation using a multi-layer perceptron (MLP). The process 1300 can fit, using the MLP, observations having a red-green-blue (RGB) value with camera rays that intersect with a window geometry associated with the window to the initial partial environment map. In some cases, it can be assumed that the dominant light source (e.g., the sun or other outdoor light source) are at least visible in one of the input images. The approach can include using the MLP approach to fit the observations as follows: Lᵢ=MLP_{ENVMAP}(ω). The observations can be the RGB values whose camera rays intersect with the window geometry.

In another aspect, the process 1300 can include generating spatially varying material properties associated with the scene (e.g., the material data 412 as shown in FIG. 4). The spatially varying material properties can include at least one of albedo values, roughness values, or metallic values associated with the scene (e.g., see the images 920 in FIG. 9B). The spatially varying material properties can be represented via a bidirectional reflectance distribution function defined on each surface point in the scene. The bidirectional reflectance distribution function can represent an estimate of the albedo values, the roughness values and the metallic values.

The optimization feature 424 of FIG. 4 can include apply a differentiable rendering algorithm (e.g., implemented by the differentiable renderer 416 of FIG. 4) to refine an estimate of emitter parameters. In one aspect, the differentiable rendering algorithm compares 422 rendered pixel values (e.g., the rendered images or pixel value 418 of FIG. 4) to input image pixel values (e.g., the input images 420 of FIG. 4) to generate a comparison value (e.g., the comparison 422 of FIG. 4). The differentiable rendering algorithm (e.g., implemented by the differentiable renderer 416) can include, by way of example, one or more of an inverse path tracing process and/or a neural implicit evolution process. Other differentiable rendering algorithms can be used as well.

The comparison 422 can be via the following:

$${min}_{η} {\vert \vert L ( x , {ω}_{o} ) - I ( x , {ω}_{o} ) \vert \vert}_{2} * \overline{α} ( x ) ,$$

where L(x, ωₒ) is the rendered pixel value 418, and I(x, ωₒ) is the pixel value from the training images 420, α̅ is the binary emission mask 408, and emitter parameters could be the emission value η or parameters of the environment map MLP. The comparison 422 can generate a loss (via a forward pass of a neural network) which can be back-propagated as gradients back to an emitter parameterization model so that the emitter can be optimized. The back-propagation can tune the parameters of a neural network associated with the emitter initialization engine 414. Optimization can be of the scalar value (the global radiance values) or for the MLPₑₙᵥₘₐₚ(ω). The system can perform fast rendering Lₒ on each view with pre-computed terms and then can use the rendering loss to optimize emitter parameters.

In one aspect, differentiable rendering is used to further refine the estimation of emitter parameters with the estimated BRDF fixed.

The process 1300 can the include optimizing, based on the comparison value, one or more of first light source geometry and/or second light source geometry (e.g., the optimization feature 424 of FIG. 4).

In some examples, the processes described herein (e.g., process 1300 and/or other process described herein) may be performed by a computing device or apparatus (e.g., the computing system 1400 of FIG. 14). For example, an apparatus (e.g., the computing system 1400 of FIG. 14) for performing light source estimation can include at least one memory (e.g., memory 1415 of FIG. 14) and at least one processor (e.g., processor 1410 of FIG. 14) coupled to at least one memory and configured to: obtain an estimated scene geometry based on a multi-view observation of a scene; obtain a light emission mask based on the multi-view observation of the scene; obtain an emitted radiance field based on the multi-view observation of the scene; and determine, based on the light emission mask and the emitted radiance field, a geometry of at least one light source of the estimated scene geometry.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 1300 is illustrated as a logical flow diagrams, the operation of which represent a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 1300 and/or other process described herein, may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 14 is a diagram illustrating an example of a system for implementing certain aspects of the present technology. In particular, FIG. 14 illustrates an example of computing system 1400, which may be for example any computing device making up internal computing system, a remote computing system, a camera, or any component thereof in which the components of the system are in communication with each other using connection 1405. Connection 1405 may be a physical connection using a bus, or a direct connection into processor 1410, such as in a chipset architecture. Connection 1405 may also be a virtual connection, networked connection, or logical connection.

In some aspects, computing system 1400 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 1400 includes at least one processing unit (CPU or processor) 1410 and connection 1405 that communicatively couples various system components including system memory 1415, such as read-only memory (ROM) 1420 and random access memory (RAM) 1425 to processor 1410. Computing system 1400 may include a cache 1415 of high-speed memory connected directly with, in close proximity to, or integrated as part of processor 1410.

Processor 1410 may include any general-purpose processor and a hardware service or software service, such as services 1432, 1434, and 1436 stored in storage device 1430, configured to control processor 1410 as well as a special-purpose processor where software instructions are incorporated into the actual processor design. Processor 1410 may essentially be a completely self-contained computing system, containing multiple cores or processors, a bus, memory controller, cache, etc. A multi-core processor may be symmetric or asymmetric.

To enable user interaction, computing system 1400 includes an input device 1445, which may represent any number of input mechanisms, such as a microphone for speech, a touch-sensitive screen for gesture or graphical input, keyboard, mouse, motion input, speech, etc. Computing system 1400 may also include output device 1435, which may be one or more of a number of output mechanisms. In some instances, multimodal systems may enable a user to provide multiple types of input/output to communicate with computing system 1400.

Computing system 1400 may include communications interface 1440, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug. 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1440 may also include one or more Global Navigation Satellite System (GNSS) receivers or transceivers that are used to determine a location of the computing system 1400 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1430 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 1430 may include software services, servers, services, etc., that when the code that defines such software is executed by the processor 1410, it causes the system to perform a function. In some aspects, a hardware service that performs a particular function may include the software component stored in a computer-readable medium in connection with the necessary hardware components, such as processor 1410, connection 1405, output device 1435, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B. C. or A and B, or A and C, or B and C. A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Illustrative aspects of the disclosure include:

Aspect 1. An apparatus for performing light source estimation, comprising: at least one memory; and at least one processor coupled to at least one memory and configured to: obtain an estimated scene geometry based on a multi-view observation of a scene; obtain a light emission mask based on the multi-view observation of the scene; obtain an emitted radiance field based on the multi-view observation of the scene; and determine, based on the light emission mask and the emitted radiance field, a geometry of at least one light source of the estimated scene geometry.

Aspect 2. The apparatus of Aspect 1, wherein the at least one processor is configured to: generate an individual shape for the at least one light source.

Aspect 3. The apparatus of any of Aspects 1 to 2, wherein the at least one processor is configured to: generate a hole defined in a wall in the scene, where the hole represents the at least one light source.

Aspect 4. The apparatus of Aspect 3, wherein the hole corresponds to a window in the wall.

Aspect 5. The apparatus of any of Aspects 1 to 4, wherein the scene comprises an indoor scene.

Aspect 6. The apparatus of any of Aspects 1 to 5, wherein the estimated scene geometry is represented as a signed distance function.

Aspect 7. The apparatus of Aspect 6, wherein the signed distance function comprises a continuous function f that, for a given three-dimensional point, returns a value representing a distance of the given three-dimensional point to a closest surface in the scene.

Aspect 8. The apparatus of any of Aspects 1 to 7, wherein the estimated scene geometry is generated based on at least one of depth fusion, monocular depth estimation, multiview stereo, or neural radiance field.

Aspect 9. The apparatus of any of Aspects 1 to 8, wherein the light emission mask includes information indicating a likelihood of a respective surface point in the scene being associated with emission of light.

Aspect 10. The apparatus of Aspect 9, wherein the light emission mask comprises a first value for surface points associated with emission of light and a second value for surface points not associated with emission of light, the second value being different from the first value.

Aspect 11. The apparatus of any of Aspects 1 to 10, wherein a first light source of the at least one light source comprises an indoor light and a second light source of the at least one light source comprises a window.

Aspect 12. The apparatus of Aspect 11, wherein the first light source is represented as having physical properties modeled as global radiance values.

Aspect 13. The apparatus of Aspect 12, wherein the at least one processor is configured to: determine the global radiance values based on sampling the emitted radiance field on surface locations of the first light source to generate sampled data and determine a mean value of the sampled data.

Aspect 14. The apparatus of Aspect 13, wherein the at least one processor is configured to: represent the first light source as a semantic object with implicit geometry associated with a signed distance function (SDF) to generate implicit SDF parameters.

Aspect 15. The apparatus of Aspect 14, wherein the at least one processor is configured to: convert the implicit SDF parameters to a set of triangles.

Aspect 16. The apparatus of Aspect 15, wherein the at least one processor is configured to: sample a set of points of a respective triangle of the set of triangles to generate sampled data; determine, for the respective triangle, whether the mean value of the sampled data is greater than a threshold value; classify the respective triangle as an emitter based on the mean value of the sampled data being greater than the threshold value for the respective triangle; and classify the respective triangle as a non-emitter based on the mean value of the sampled data is at or below the threshold value for the respective triangle.

Aspect 17. The apparatus of Aspect 16, wherein the at least one processor is configured to: determine the respective triangle intersects with a camera ray; based on the respective triangle intersecting with the camera ray, obtain a pixel value corresponding to the respective triangle to generate a set of pixel values; and set an emission value for a median value of the set of pixel values.

Aspect 18. The apparatus of any one of Aspects 11 to 17, wherein the multi-view observation of the scene comprises at least one input image in which a dominant light source is viewable through the window, and wherein the at least one processor is configured to: estimate an initial partial environment map based on sampled camera rays and corresponding image intensity scattered onto a global environmental map; convert the initial partial environment map to an implicit representation using a multi-layer perceptron (MLP); and fit, using the MLP, observations having a red-green-blue (RGB) value with camera rays that intersect with a window geometry associated with the window to the initial partial environment map.

Aspect 19. The apparatus of any of Aspects 1 to 18, wherein the at least one processor is configured to: generate spatially varying material properties associated with the scene.

Aspect 20. The apparatus of Aspect 19, wherein the spatially varying material properties comprise at least one of albedo values, roughness values, or metallic values associated with the scene.

Aspect 21. The apparatus of Aspect 20, wherein the spatially varying material properties are represented via a bidirectional reflectance distribution function defined on each surface point in the scene.

Aspect 22. The apparatus of Aspect 21, wherein the bidirectional reflectance distribution function represents an estimate of the albedo values, the roughness values and the metallic values.

Aspect 23. The apparatus of Aspect 22, wherein the at least one processor is configured to: apply a differentiable rendering algorithm to refine an estimate of emitter parameters.

Aspect 24. The apparatus of Aspect 23, wherein the differentiable rendering algorithm compares rendered pixel values to input image pixel values to generate a comparison value.

Aspect 25. The apparatus of Aspect 24, wherein the at least one processor is configured to: optimize, based on the comparison value, at least one of first light source geometry or second light source geometry.

Aspect 26. The apparatus of any one of Aspects 24 or 25, wherein the differentiable rendering algorithm comprises one of inverse path tracing or neural implicit evolution.

Aspect 27. A method for performing light source estimation, the method comprising: obtaining an estimated scene geometry based on a multi-view observation of a scene; obtaining a light emission mask based on the multi-view observation of the scene; obtaining an emitted radiance field based on the multi-view observation of the scene; and determining, based on the light emission mask and the emitted radiance field, a geometry of at least one light source of the estimated scene geometry.

Aspect 28. The method of Aspect 27, wherein the at least one processor is configured to: generate an individual shape for the at least one light source.

Aspect 29. The method of any one of Aspects 27 or 28, wherein the at least one processor is configured to: generate a hole defined in a wall in the scene, where the hole represents the at least one light source.

Aspect 30. The method of Aspect 29, wherein the hole corresponds to a window in the wall.

Aspect 31. The method of any one of Aspects 27 to 30, wherein the scene comprises an indoor scene.

Aspect 32. The method of any one of Aspects 27 to 31, wherein the estimated scene geometry is represented as a signed distance function.

Aspect 33. The method of Aspect 32, wherein the signed distance function comprises a continuous function f that, for a given three-dimensional point, returns a value representing a distance of the given three-dimensional point to a closest surface in the scene.

Aspect 34. The method of any one of Aspects 27 to 33, wherein the estimated scene geometry is generated based on at least one of depth fusion, monocular depth estimation, multiview stereo, or neural radiance field.

Aspect 35. The method of any one of Aspects 27 to 34, wherein the light emission mask includes information indicating a likelihood of a respective surface point in the scene being associated with emission of light.

Aspect 36. The method of Aspect 35, wherein the light emission mask comprises a first value for surface points associated with emission of light and a second value for surface points not associated with emission of light, the second value being different from the first value.

Aspect 37. The method of any one of Aspects 27 to 36, wherein a first light source of the at least one light source comprises an indoor light and a second light source of the at least one light source comprises a window.

Aspect 38. The method of Aspect 37, wherein the first light source is represented as having physical properties modeled as global radiance values.

Aspect 39. The method of Aspect 38, wherein the at least one processor is configured to: determine the global radiance values based on sampling the emitted radiance field on surface locations of the first light source to generate sampled data and determine a mean value of the sampled data.

Aspect 40. The method of Aspect 39, wherein the at least one processor is configured to: represent the first light source as a semantic object with implicit geometry associated with a signed distance function (SDF) to generate implicit SDF parameters.

Aspect 41. The method of Aspect 40, wherein the at least one processor is configured to: convert the implicit SDF parameters to a set of triangles.

Aspect 42. The method of Aspect 41, wherein the at least one processor is configured to: sample a set of points of a respective triangle of the set of triangles to generate sampled data; determine, for the respective triangle, whether the mean value of the sampled data is greater than a threshold value; classify the respective triangle as an emitter based on the mean value of the sampled data being greater than the threshold value for the respective triangle; and classify the respective triangle as a non-emitter based on the mean value of the sampled data is at or below the threshold value for the respective triangle.

Aspect 43. The method of Aspect 42, wherein the at least one processor is configured to: determine the respective triangle intersects with a camera ray; based on the respective triangle intersecting with the camera ray, obtain a pixel value corresponding to the respective triangle to generate a set of pixel values; and set an emission value for a median value of the set of pixel values.

Aspect 44. The method of any one of Aspect 37 to 43, wherein the multi-view observation of the scene comprises at least one input image in which a dominant light source is viewable through the window, and wherein the at least one processor is configured to: estimate an initial partial environment map based on sampled camera rays and corresponding image intensity scattered onto a global environmental map; convert the initial partial environment map to an implicit representation using a multi-layer perceptron (MLP); and fit, using the MLP, observations having a red-green-blue (RGB) value with camera rays that intersect with a window geometry associated with the window to the initial partial environment map.

Aspect 45. The method of any one of Aspects 27 to 44, wherein the at least one processor is configured to: generate spatially varying material properties associated with the scene.

Aspect 46. The method of Aspect 45, wherein the spatially varying material properties comprise at least one of albedo values, roughness values, or metallic values associated with the scene.

Aspect 47. The method of Aspect 46, wherein the spatially varying material properties are represented via a bidirectional reflectance distribution function defined on each surface point in the scene.

Aspect 48. The method of Aspect 47, wherein the bidirectional reflectance distribution function represents an estimate of the albedo values, the roughness values and the metallic values.

Aspect 49. The method of Aspect 48, wherein the at least one processor is configured to: apply a differentiable rendering algorithm to refine an estimate of emitter parameters.

Aspect 50. The method of Aspect 49, wherein the differentiable rendering algorithm compares rendered pixel values to input image pixel values to generate a comparison value.

Aspect 51. The method of Aspect 50, wherein the at least one processor is configured to: optimize, based on the comparison value, at least one of first light source geometry or second light source geometry.

Aspect 52. A non-transitory computer-readable medium having stored thereon instructions that, when executed by one or more processors, cause the one or more processors to perform operations according to any of Aspects 27 to 51.

Aspect 53. An apparatus for performing light source estimation, the apparatus including one or more means for performing operations according to any of Aspects 27 to 51.

What is claimed is:

1. An apparatus for performing light source estimation, comprising:
at least one memory; and
at least one processor coupled to at least one memory and configured to:
obtain an estimated scene geometry based on a multi-view observation of a scene;
obtain a light emission mask based on the multi-view observation of the scene;
obtain an emitted radiance field based on the multi-view observation of the scene; and
determine, based on the light emission mask and the emitted radiance field, a geometry of at least one light source of the estimated scene geometry.

2. The apparatus of claim 1, wherein the at least one processor is configured to:
generate an individual shape for the at least one light source.

3. The apparatus of claim 1, wherein the at least one processor is configured to:
generate a hole defined in a wall in the scene, where the hole represents the at least one light source.

4. The apparatus of claim 3, wherein the hole corresponds to a window in the wall.

5. The apparatus of claim 1, wherein the scene comprises an indoor scene.

6. The apparatus of claim 1, wherein the estimated scene geometry is represented as a signed distance function.

7. The apparatus of claim 6, wherein the signed distance function comprises a continuous function f that, for a given three-dimensional point, returns a value representing a distance of the given three-dimensional point to a closest surface in the scene.

8. The apparatus of claim 1, wherein the estimated scene geometry is generated based on at least one of depth fusion, monocular depth estimation, multiview stereo, or neural radiance field.

9. The apparatus of claim 1, wherein the light emission mask includes information indicating a likelihood of a respective surface point in the scene being associated with emission of light.

10. The apparatus of claim 9, wherein the light emission mask comprises a first value for surface points associated with emission of light and a second value for surface points not associated with emission of light, the second value being different from the first value.

11. The apparatus of claim 1, wherein a first light source of the at least one light source comprises an indoor light and a second light source of the at least one light source comprises a window.

12. The apparatus of claim 11, wherein the first light source is represented as having physical properties modeled as global radiance values.

13. The apparatus of claim 12, wherein the at least one processor is configured to:
determine the global radiance values based on sampling the emitted radiance field on surface locations of the first light source to generate sampled data and determine a mean value of the sampled data.

14. The apparatus of claim 13, wherein the at least one processor is configured to:
represent the first light source as a semantic object with implicit geometry associated with a signed distance function (SDF) to generate implicit SDF parameters.

15. The apparatus of claim 14, wherein the at least one processor is configured to:
convert the implicit SDF parameters to a set of triangles.

16. The apparatus of claim 15, wherein the at least one processor is configured to:
sample a set of points of a respective triangle of the set of triangles to generate sampled data;
determine, for the respective triangle, whether the mean value of the sampled data is greater than a threshold value;
classify the respective triangle as an emitter based on the mean value of the sampled data being greater than the threshold value for the respective triangle; and
classify the respective triangle as a non-emitter based on the mean value of the sampled data is at or below the threshold value for the respective triangle.

17. The apparatus of claim 16, wherein the at least one processor is configured to:
determine the respective triangle intersects with a camera ray;
based on the respective triangle intersecting with the camera ray, obtain a pixel value corresponding to the respective triangle to generate a set of pixel values; and
set an emission value for a median value of the set of pixel values.

18. The apparatus of claim 11, wherein the multi-view observation of the scene comprises at least one input image in which a dominant light source is viewable through the window, and wherein the at least one processor is configured to:
estimate an initial partial environment map based on sampled camera rays and corresponding image intensity scattered onto a global environmental map;
convert the initial partial environment map to an implicit representation using a multi-layer perceptron (MLP); and
fit, using the MLP, observations having a red-green-blue (RGB) value with camera rays that intersect with a window geometry associated with the window to the initial partial environment map.

19. The apparatus of claim 1, wherein the at least one processor is configured to:
generate spatially varying material properties associated with the scene.

20. The apparatus of claim 19, wherein the spatially varying material properties comprise at least one of albedo values, roughness values, or metallic values associated with the scene.

21. The apparatus of claim 20, wherein the spatially varying material properties are represented via a bidirectional reflectance distribution function defined on each surface point in the scene.

22. The apparatus of claim 21, wherein the bidirectional reflectance distribution function represents an estimate of the albedo values, the roughness values and the metallic values.

23. The apparatus of claim 22, wherein the at least one processor is configured to:
apply a differentiable rendering algorithm to refine an estimate of emitter parameters.

24. The apparatus of claim 23, wherein the differentiable rendering algorithm compares rendered pixel values to input image pixel values to generate a comparison value.

25. The apparatus of claim 24, wherein the at least one processor is configured to:
optimize, based on the comparison value, at least one of first light source geometry or second light source geometry.

26. The apparatus of claim 24, wherein the differentiable rendering algorithm comprises one of inverse path tracing or neural implicit evolution.

27. A method for performing light source estimation, the method comprising:
obtaining an estimated scene geometry based on a multi-view observation of a scene;
obtaining a light emission mask based on the multi-view observation of the scene;
obtaining an emitted radiance field based on the multi-view observation of the scene; and
determining, based on the light emission mask and the emitted radiance field, a geometry of at least one light source of the estimated scene geometry.

28. The method of claim 27, further comprising:
generate an individual shape for the at least one light source.

29. The method of claim 27, wherein a first light source of the at least one light source comprises an indoor light and a second light source of the at least one light source comprises a window.

30. The method of claim 29, wherein the first light source is represented as having physical properties modeled as global radiance values.
